(19) United States
(12) Patent Application Publication
(10) Pub. No.: US 2024/0173674 A1
(43) Pub. Date: May 30, 2024

(54) FUEL CELL HUMIDIFICATION POTTING ADHESIVE SHROUD

(71) Applicant: Parker-Hannifin Corporation, Cleveland, OH (US)

(72) Inventor: David Duryea, Franklin, TN (US)

(73) Assignee: Parker-Hannifin Corporation, Cleveland, OH (US)

(21) Appl. No.: 18/437,799

(22) Filed: Feb. 9, 2024

Related U.S. Application Data
(63) Continuation of application No. PCT/US2022/041179, filed on Aug. 23, 2022.
(60) Provisional application No. 63/235,877, filed on Aug. 23, 2021.

(51) Int. Cl. B01D 63/02; H01M 8/04119

(52) U.S. Cl. CPC B01D 63/022; B01D 2313/23; B01D 2323/52; H01M 8/04149

(57) ABSTRACT

A separation and/or humidification element that employs fibrous hollow membrane tubes is provided, which may be used for water vapor transfer between different gas streams in a fuel cell application, such as to humidify the reaction gas. At least one and typically two composite end caps encapsulate ends of a bundle of the fibrous hollow membrane tubes. Each composite end cap comprises adhesive (e.g. epoxy) and a preform such as a plastic annular shroud.

### CROSS-REFERENCE TO RELATED PATENT APPLICATIONS

This patent application is a continuation of co-pending U.S. PCT Patent Application No. PCT/US2022/041179, filed Aug. 23, 2022, which is now pending, the entire teachings and disclosure of which are incorporated herein by reference thereto. This patent application claims the benefit of U.S. Provisional Patent Application No. 63/235,877, filed Aug. 23, 2021, the entire teachings and disclosure of which are incorporated herein by reference thereto.

### FIELD OF THE INVENTION

The subject invention relates generally to elements with hollow membrane tubes (e.g. hollow fibers) useful for removing moisture in an air stream for a fuel cell.

### BACKGROUND OF THE INVENTION

Bundles of fiber hollow membrane tubes are used as elements in humidifiers for fuel cells for humidifying the gas stream to be used therein. Such humidifiers may be exemplified in the art by U.S. Patent or U.S. Publication Nos. 2010/0190093 to Lee; 2011/0195325 to Altmuller et al.; 8,181,943 to Leister; U.S. Pat. No. 9,570,767 to Kim et al. For example, the exhaust air gas stream from the fuel cell may be “wet” (high humidity) and the water vapor therein can be used to humidify the drier reaction air for use in the electrochemical reaction of the fuel cell. As seen in U.S. Publication No. 2010/0190093 to Lee, typically such a humidification hollow fiber membrane comprises a collection bundle of hollow membrane tubes (e.g. hollow fiber membranes) and fixation adhesive proximate each end of the fiber bundle (which may be referred to as “end caps”). These end caps fill the interstices and regions between adjacent fibers and fix the fiber membrane at both sides of the housing.

While many arrangements have permanent housings for the fiber membrane bundle (e.g. of hollow membrane tubes 12) as exemplified by at least some of the referenced publications, it is also know to have a membrane element with end caps for removable use in a housing. A current assembly may utilize a 2-part epoxy-type adhesive for both end caps. The ends of the pre-cut fibers are collected together in a ring and located within an appropriate mold with a predetermined geometry, and the adhesive is then allowed to flow around the fiber ends and assume the geometry of the mold. After the adhesive is cured, the ends are then finished, such as by heating and slicing the encased ends to expose the fiber ends for use.

Some of the disadvantages of such a process is that adhesive is relatively expensive. Additionally, molds and tooling are required to pour the adhesive and use as potting to stabilize the hollow fibers. The potted adhesive can also out-gas under certain circumstances, which can cause unsightly bubbles.

Various concepts relating to the state of the art may also include U.S. Pat. Nos. 6,653,012; 6,956,635; 7,040,606; 7,156,379; 7,264,725; 7,828,155; 7,938,386, 8,414,693; 9,034,528; and 9,048,469; and US Publication No. 20080067700. However, these are not seen to address deficiencies in the art nor the improvements of the present disclosure.

### BRIEF SUMMARY OF THE INVENTION

A concept of the present application, is to replace the adhesive end caps of a humidification filter element for fuel cells with a pre-formed plastic (or other material) shroud and adhesive combination, to aid with manufacturing, handling, performance, and reduce adhesive costs.

According to some embodiments, the proposal is to insert a relatively thin, annular plastic component (shroud) into the mold before the adhesive is applied. The plastic component has an outer geometry that essentially matches the inner geometry of the mold. The ends of the fibers are then inserted into the component, and the adhesive is then allowed to flow internal to the component and around the fiber ends. The ends of the element are finished as before, such as by heating and slicing the ends of the encased fibers to reveal the fiber ends. The shroud may also replace the molds entirely. Depending on the axial length of the shroud, the end of the shroud may also be cut during the finishing process.

The shroud may take on different shapes and sizes, depending on the application. The new potted adhesive ends would still encapsulate all the open ends of the hollow fibers, but now would become completely cylindrical, allowing the shroud to form the contoured exterior periphery of the element.

By inserting a preform shroud into the mold (or eliminating the molds due to the shroud design), the new design will use less adhesive, thereby saving money, as well as eliminate the need for additional tooling and mold requirements. Using a plastic pre-formed shroud would also help to conceal bubbles within the adhesive.

In summary, potted adhesive would be replaced in part by a pre-formed, functional piece of molded plastic (or other material). The annular shroud would serve as both part of the exterior finish of the humidification element as well as a permanent mold for the remainder of the potted adhesive.

An inventive aspect of the present invention is directed to an element comprising a bundle of hollow membrane tubes. The hollow membrane tubes have opposite open ends for passage of a fluid stream therethrough. First and second end caps are proximate opposite open ends, respectively. First and second seal surfaces are provided by the first and second end caps, respectively. The first and second seal surfaces face outwardly and are freely engageable for facilitating a releasable seal. An intermediate region of the bundle of hollow membranes tubes is externally exposed between the first and second end caps. Each of the first and second end caps are at least partially formed with an adhesive. At least one of the first and second end caps is a composite end cap comprising the adhesive in combination with a preform. The adhesive fills interstices between the hollow membrane tubes, with the preform at least partially surrounding the bundle of hollow membrane tubes and integrally bonded thereto with the adhesive.

Various features may be used in the above aspect either alone and/or in combination with each other as provided in below paragraphs.

Although at least one of the end caps is a composite end cap, preferably, both of the first and second end caps are composite end caps, each preferably with its own preform.

For example, the first end cap can have a first annular shroud as the preform; and the second end can include a second annular shroud as the preform. In some embodiments, the first annular shroud and the second annular shroud have different configurations allowing for different characteristics and/or functions, but in some embodiments the first and second annular shrouds can be of a common configuration allowing interchangeability.

Each of the first and second seals surfaces may comprise: (a) a free radially or axially directed annular surface of the first end cap or the second end cap; (b) a elastomeric ring gasket mounted to the first end cap or the second end cap; or (c) a lip seal integrally formed by the first end cap or the second end cap.

The adhesive for the composite end cap may take the form of an overmold that overmolds the preform to the composite end cap, wherein the preform provides at least part of the outermost radial surface of the composite end cap and the adhesive defines a molded surface overlapping the preform.

By forming the outermost radial surface, a toleranced predetermined surface can be provided for facilitating one of the seal surfaces.

Typically, each of the first and second end caps comprises a cut end through the adhesive thereof exposing opposite open ends.

In some embodiments, the preform (along with adhesive) is cut co-planar with the cut end for at least one of the first and second end caps. In other embodiments, the preform may not be cut, and only adhesive may be cut.

The preform can comprise a ring portion fully surrounding the bundle.

The element may optionally include a perforated cage surrounding the bundle of hollow membrane tubes extending between the first and second end caps. This may provide structural support and/or protection.

In some embodiments, the first end cap is an open end cap and the second end cap is a closed end cap. In such an arrangement, the bundle of hollow membrane tubes is arranged in a ring defining a central cavity opening into an opening through the open end cap and closed at the closed end cap.

In some embodiments, the first and second end caps are both closed end caps, with passage therethrough being restricted to passage through the hollow membrane tubes via the opposite open ends thereof.

Preferably, the adhesive comprises polyurethane or epoxy.

Preferably, the preform comprises plastic, but may also be metal (or may also be some other material providing predetermined geometry).

The element can be incorporated into an assembly comprising in combination with a housing with the element removably installed therein. The element forms first and second seals with the first and second seal surfaces. The housing comprises: a first inlet and a first outlet, with a first flow passageway travelling from the first inlet through the hollow membrane tubes and opposite open ends thereof to the first outlet; and a second inlet and a second outlet, with a second flow passageway through the intermediate region. In this manner the assembly is operable such that moisture is transferred from the first flow passageway to the second flow passageway, or vice versa depending upon whether the first or second flow passageway has a higher moisture content.

An aspect is also directed toward an a method for forming an element, comprising: collecting a bundle of hollow membrane tubes; applying a first composite end cap on a first end of the bundle with a first preform and adhesive; curing the adhesive to encapsulate the bundle of hollow membrane tubes in the adhesive of the first composite end cap; and cutting through the first composite end cap and the first end of the bundle to expose open ends of the hollow membrane tubes at the first end (such cutting may or may not cut through the first preform).

The method of may also comprise arranging an elastomeric gasket on the first composite end cap having a housing sealing surface.

The method may be used with a mold in some embodiments or the preform may be used to hold liquid adhesive avoiding the need for a mold in other embodiments.

In a method using a mold the applying the first composite end cap comprises: i. locating a first annular shroud as the first preform within a first mold having a cavity of a predetermined annular geometry, the first annular shroud having an outer periphery substantially matching the annular geometry of the first mold; ii. inserting a first end of the bundle into the mold, such that ends of the hollow membrane tubes are internal of the first annular shroud; and iii. applying adhesive into the first mold internal to the bundle to encapsulate the ends of the hollow membrane tubes.

Preferably, both end caps are composite end caps, in which the method further comprises: applying a second composite end cap on a second end of the bundle with a second preform and adhesive; curing the adhesive to encapsulate the bundle of hollow membrane tubes in the adhesive of the second composite end cap; cutting through the second composite end cap and the second end of the bundle to expose open ends of the hollow membrane tubes at the second end (such cutting may or may not cut through the second preform); and maintaining exposure of an intermediate region of the bundle of hollow membranes tubes between the first and second composite end caps.

Similar to the first end cap, if a mold is used for the second end cap said applying the second composite end cap comprises: i. locating a second annular shroud as the second preform within a second mold having a cavity of a predetermined annular geometry, the second annular shroud having an outer periphery substantially matching the annular geometry of the second mold; ii. inserting the second end of the bundle into the mold, such that ends of the hollow membrane tubes are internal of the second annular shroud; and iii. applying adhesive into the second mold internal to the bundle to encapsulate the ends of the hollow membrane tubes.

Another aspect is directed toward a filter element including a ring of collected hollow fibers having a predetermined length, and end cap assemblies provided at each of the fiber ring, each end cap assembly including i) an annular pre-formed peripheral shroud surrounding the ends of the fibers; and ii) adhesive within the shroud and encapsulating the ends of the fibers. Any of the above or below features may be incorporated into this aspect as well.

Yet another aspect is directed toward a method for forming a filter element, comprising the steps of: i. collecting hollow fibers into a ring; ii. locating an annular shroud within a mold having a cavity of a predetermined cylindrical geometry, the shroud having an outer periphery substantially matching the inner geometry of the mold; iii. inserting an end of the ring of fibers into the mold, such that ends of the fibers are internal of the shroud; iv. applying adhesive into the mold internal to the ring to encapsulate the ends of the fibers; v. curing the adhesive; and vi. finishing the end of the fiber ring to reveal the fiber ends. Any of the above or below features may be incorporated into this aspect as well.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a side view of a separation and/or humidification element in accordance with an embodiment of the present invention;

FIG. 2 is a cross section of the separation and/or humidification element shown in FIG. 1 (through section A-A), at a step prior to cutting opposite end caps to expose open passages of the hollow membrane tubes (the hollow membrane tube being illustrated schematically);

FIG. 3 is a cross section of the separation and/or humidification element shown in FIG. 1 also through section A-A (and similar to FIG. 2 but at a subsequent step after the opposite end caps are cut to expose open passages of the hollow membrane tube) and with internal and external ring gaskets provided; and

FIG. 4 is a schematic illustration of a fuel cell humidification assembly including a housing that can incorporate an installable and removable element such as that of FIG. 1 used a water vapor separator and humidifier being used in a fuel cell for humidifying the gas stream to be used in the fuel cell;

FIG. 5, is a schematic illustration of another embodiment of a fuel cell humidification assembly similar to that of FIG. 4 that can also incorporate an installable and removable element, but with two closed end caps rather than one open and one closed end cap, facilitating different gas flow passages;

FIG. 6, is an embodiment of a mold along with a plastic shroud preform installed therein ready to receive one end of a bundle of hollow membrane tubes for adhesive potting (e.g. molding using adhesive such as epoxy), which may be used to form the closed end of a separation and/or humidification element such as shown in FIG. 4;

FIG. 7, is an embodiment of a mold along with a plastic shroud preform (two pieces) installed therein ready to receive the opposite end of the bundle of hollow membrane tubes for adhesive potting (e.g. molding using adhesive such as epoxy), which may be used to form the open end of a separation and/or humidification element such as shown in FIG. 4; and

FIGS. 8 and 9 are embodiments of plastic component end caps useable in molds of FIGS. 6 and 7 for capping a bundle of hollow membrane tubes and that may be potted with adhesive to opposite ends of the bundle of hollow membrane tubes in molds and then subsequently cut to expose open ends of the hollow membrane tubes.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

In accordance with an embodiment of the present invention, FIGS. 1-3 illustrate a separation and/or humidification element 10. Element 10 may also be referred to as a filter element in that uses a membrane media to separate water vapor from a gas stream which can be released into another drier gas stream regenerating the membrane separation capacity. The element 10 employs hollow membrane tubes 12 (e.g. typically fiber type membrane) that is operable to exchange humidity between two fluid streams. For example, the hollow membrane tubes 12 that can convey a gas stream through the hollow interior thereof separate from the external gas stream surrounding the tubes 12. The membrane material of the tubes 12 facilitates passage of the water vapor from the high humidity gas stream to the lower humidity gas stream, while at the same time effectively preventing transfer of other gases that are desirably maintained in separation.

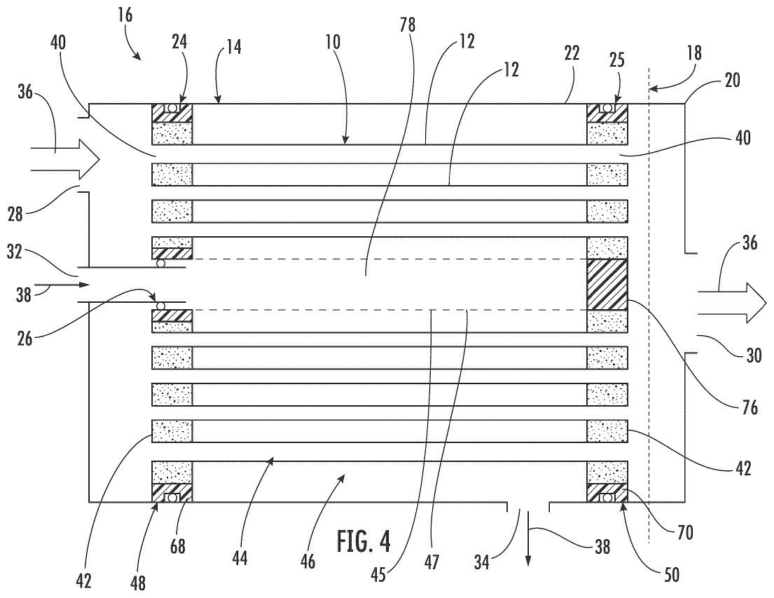

Before turning to greater details of the element 10, description of an example operating environment will be had with reference to FIG. 4. According to an exemplary use, the element 10 is useable in combination with a housing 14 to provide a humidification assembly 16 with the element 10 removably installed in the housing 14. For example, the housing 14 can have a split 16 (shown schematically) that can provide a removable cover 20 allowing installation and removal of the element 10 from the housing base 22.

Preferably, the element is removably sealed to the housing at least one, typically at least two and sometimes three locations 24, 25, 26 as illustrated in FIG. 4, which can better provide predetermined flow passages through the assembly and improve efficiency of water vapor transfer.

In the assembly 16, the housing comprises: a first inlet 28 and a first outlet 30; and a second inlet 32 and a second outlet 34. As shown by flow arrows in FIG. 4, the assembly 16 provides a first flow passageway 36 travelling from the first inlet 28 through the hollow membrane tubes 12 (and opposite open ends thereof) to the first outlet 30. The assembly 16 also provides a second flow passageway 38 through an intermediate region between two of the seal locations 24, 25.

The assembly 16 is operable such that moisture is transferred from the first flow passageway 36 to the second flow passageway 38, or vice versa depending upon whether the first or second flow passageway has a higher moisture content. For example, reaction gas for a fuel cell may pass along the first flow passageway 36, whereas reacted/exhaust gas having a higher humidity may pass along the second flow passageway 38 to transfer water vapor to the reaction gas to improve operating effectiveness of the fuel cell (or vice versa with reaction gas along the second flow passageway 38 and reacted/exhaust gas along the first flow passageway 36).

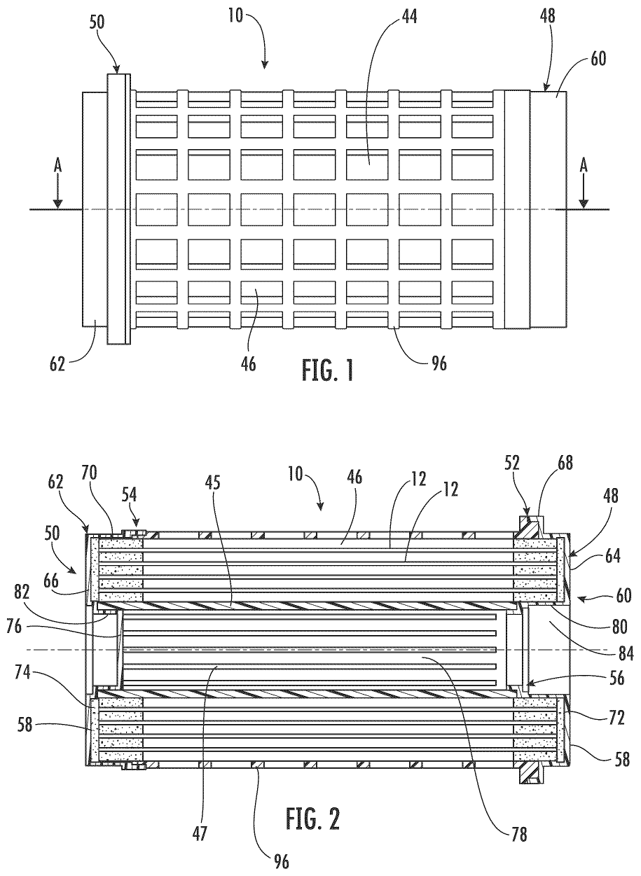

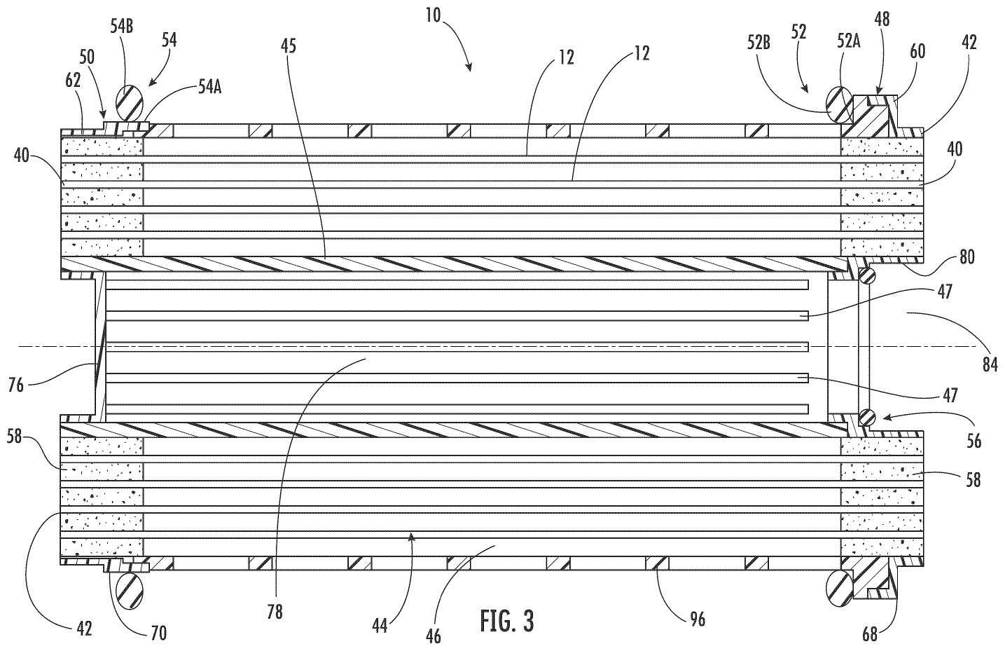

With an example operating environment understood, greater attention will be given to the structure of the element 10, shown in FIGS. 1-3. In viewing FIGS. 2 and 3, it will be understood that FIG. 2 is an unfinished element in that the ends still need to be cut to expose opposite open ends 40 of the hollow membrane tubes 12, which open ends 40 are seen with reference to FIGS. 3 and 4. In FIG. 3, the opposite ends of the element 10 are cut to provide cut end faces 42 which open opposite open ends 40 for gas passage through the hollow passages of the hollow membrane tubes 12.

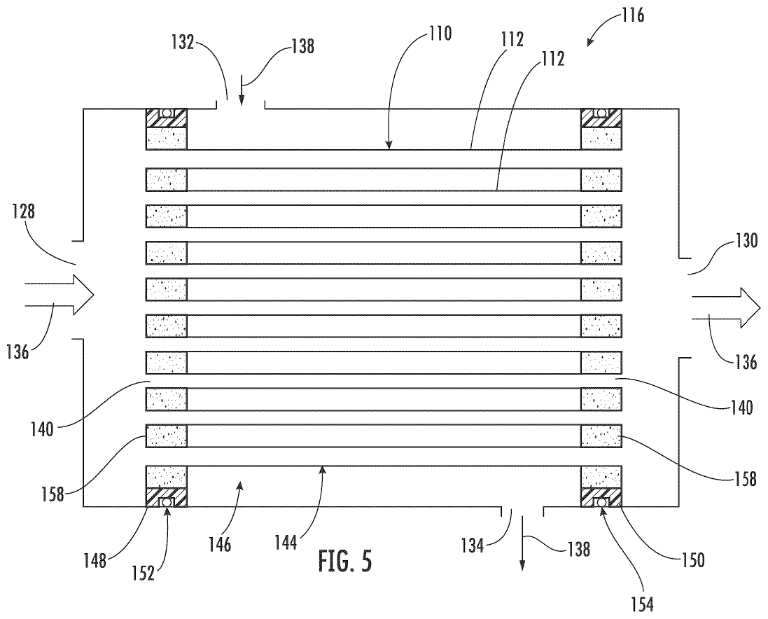

The hollow membrane tubes are arranged in a bundle 44, and in this embodiment are in the shape of a ring as shown, although can also be in the form of other collection including those without a centralized hollow internal cavity as shown in the embodiment of FIG. 5. The bundle in FIGS. 1-4 show the bundle 40 in surrounding relation of an optional inner perforated support tube 45 (e.g. a molded plastic tube with openings 47).

First and second end caps 48, 50 (e.g. composite end caps) are at opposite ends of the bundle 44 and proximate opposite open ends 40, respectively, of the hollow membrane tubes 12 as shown in FIG. 3. An intermediate region 46 of the bundle 44 of hollow membranes tubes 12 are externally exposed between the first and second end caps 48, 50, which is the area that facilitates water vapor transfer through the hollow membrane tubes either outside-in or inside-out, depending upon where the higher water vapor content resides.

First and second seal surfaces 52, 54 are provided by the first and second end caps 48, 50, respectively (these can correspond to sealing locations 24, 25 when employed in housing 14). The first and second seal surfaces 52, 54 face outwardly and freely engageable for facilitating a releasable seal for example with the housing 14 as shown in FIG. 4. Thus the seal surfaces 52, 54 serve as what may be referred to as a housing seal. In particular, these seal surfaces 52, 54 are externally exposed to provide for an axial seal, a radial seal or combination thereof when employed with a housing and allows for release from the housing when used therein (e.g. removal or installation and/or replacement during service).

An embodiment also optionally includes third seal surface 56, which may be internally directed, which in this embodiment is preferably used because an open end cap design is employed in the FIG. 4 embodiment. As evident with reference to the FIG. 5 embodiment, this third seal is not needed and optional, for example not being used if two closed end caps are employed.

Each of the first and second seals surfaces 52, 54 can be of various configurations, and for example may comprise one or more of the following: (a) a free radially or axially directed annular surface of the first end cap or the second end cap (e.g. tightly tolerance outer radial and/or axial surfaces 52A and 54A); or more preferably a separate elastomeric ring gasket 52B, 54B (typically a different material that is more elastomeric and elastic than the composite end caps) that may be mounted to the first end cap and the second end cap (or other a lip seal integrally formed by the first end cap or the second end cap). For example, a retaining groove, adhesive, snap fit, expansion fit, retaining flange or other mount can be used for retention to the end cap.

The first and second seals surfaces 52, 54 do not need to be hermetic but preferably provide a sufficient seal for better water vapor exchange operation, in that the seal surfaces 52, 53 improve the efficiency and effectiveness of operation by preventing leakage of gas and directing the gases along their separate streams, preferably preventing bypass of at least 95% and more typically at least 99% of the gas volume of each separate gas stream at that seal location in normal operation.

Accordingly, each seal 52, 54 (and 56 if used) preferably comprises a separate elastomeric gasket (e.g. may made of any of nitriles, urethanes, EPDMs, neoprenes, silicones, butyl rubbers, fluorocarbon rubbers or other such similar rubber materials) or can be the controlled dimension and/or tolerance end cap (which can be enhanced by using a preform according to embodiments herein), or other thin flexible lip of plastics, rubber, or other such seal material, including an integral thin annular web of the preform itself that provides flexibility to compress, deflect or otherwise act as a seal, such as a wiper type seal for example.

As shown best in FIGS. 2-4 (and also the alternative embodiment of FIG. 5), each of the end caps 48, 50 are at least partially formed with an adhesive 58 (for example epoxy or polyurethane that can be applied in liquid form and cured to a solid form). Further, at least one of the first and second end caps 48, 50 and more preferably both end caps are composite end caps as shown comprising the adhesive 58 in combination with a preform; for example a first preform such as first annular shroud 60 for the first end cap 48 and a second preform such as second annular shroud 62 for the second end cap 50.

The shrouds 60, 62 are preformed material such as preferably plastic but may be other material (metal or the like,) that does not cure in place like the adhesive 58 does when applied to the tubes. The adhesive 58 fills interstices between the hollow membrane tubes 12. Each shroud 60, 62 preform at least partially surrounding the bundle of hollow membrane tubes and integrally bonded thereto with the adhesive 58.

The adhesive 58 can also couple different plastic parts together and prevent leak paths therebetween if desired. For example, the adhesive 58 may seep between and therefore couple the outer case 96, with the end caps 52, 54 and the inner support tube 45 with the end caps 52, 54.

Several advantages can be provided by using a preform in either or both of the composite end caps 48, 50, such as: cost savings in that less expensive preform materials can be used for a significant portion of the end caps in comparison to adhesive that is more costly; the preform shrouds 60, 62 can fully contain the adhesive eliminating the need for molds, or partially contain the adhesive in conjunction with molds allowing for potentially easier mold processing as well as hiding unsightly bubbles that may outgas during adhesive application and cure; and/or the preform shrouds 60, 62 can provide a predetermined and reliable outer surface that may provide a reliable tolerance outer surface and sealing surface for the composite end caps 48, 50 that is not a impacted by the cure process once released from a mold.

Further as shown in FIGS. 2-4, different configurations of shrouds 60, 62 at different ends can provide different functionalities at different ends of the element 10.

Alternatively the shrouds as well as end caps can be interchangeable (and the first end may be the second end and vice versa), as shown in the embodiment of FIG. 5, allowing for common parts to be used.

As shown in FIG. 2, each of the shrouds 60, 62 may have cover portions 64, 66 that extend radially inward from the outer surrounding ring portion 68, 70, respectively. The outer surrounding ring portions 68, 70 can provide for definition of the radial outermost profile as shown in FIGS. 1-3 and/or can facilitate the seal surfaces 52, 54 (either with or without an additional gasket).

The cover portions 64, 66 can provide for mold-free application in that the potting adhesive may be employed into annular potting wells 72, 74 provided by the shrouds 60, 62 (before being cut to re-expose open ends 40 of the hollow membrane tubes 12). Annular potting wells 72, 74 can having inner retaining walls 80, 82 that act in conjunction with the ring portions 68, 70 (and the bottom surface provided by the cover portion 64, 66) that can receive and hold the liquid adhesive for potting during the application and cure process.

Once cured, then the end portion of the element including the adhesive plugging hollow membrane tubes 12, and the cover portions of the shrouds 60, 62 can be cut off (e.g. cutting through preform through the outer surrounding ring portions 68, 70 and the inner retaining walls 80, 82). This finishes the element 10 for operative purposes as can be seen in comparing FIG. 2 (pre-cut) with FIG. 3 (finished after being cut).

Further, one end cap 48 may be an open end cap and define central opening 84 (preferably with third seal 56 as a cap surface and/or gasket) that opens into a central cavity 78 (through which one of the passageways 38 may travel along when passing through the intermediate region 46 of the bundle 44 of hollow membrane tubes 12); while the other cap 52 may also define a central plug 76 and thereby be a closed end cap for the second end cap 50.

Alternatively, neither end cap may be open with both being closed as seen with reference to the FIG. 5 embodiment.

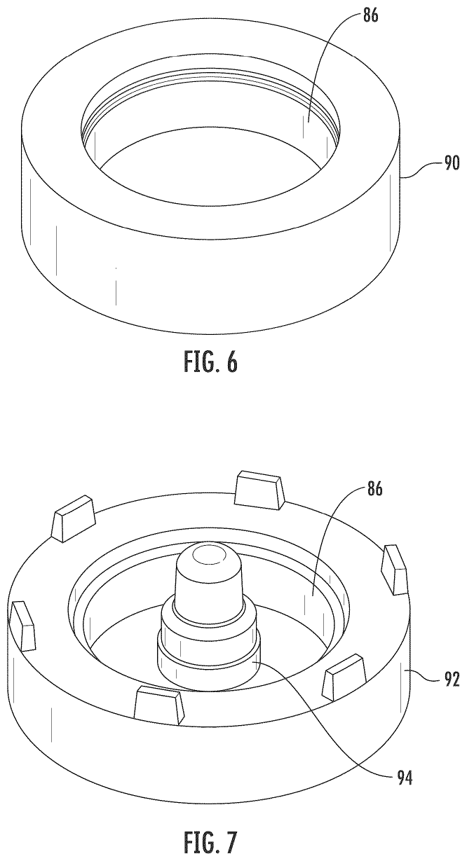

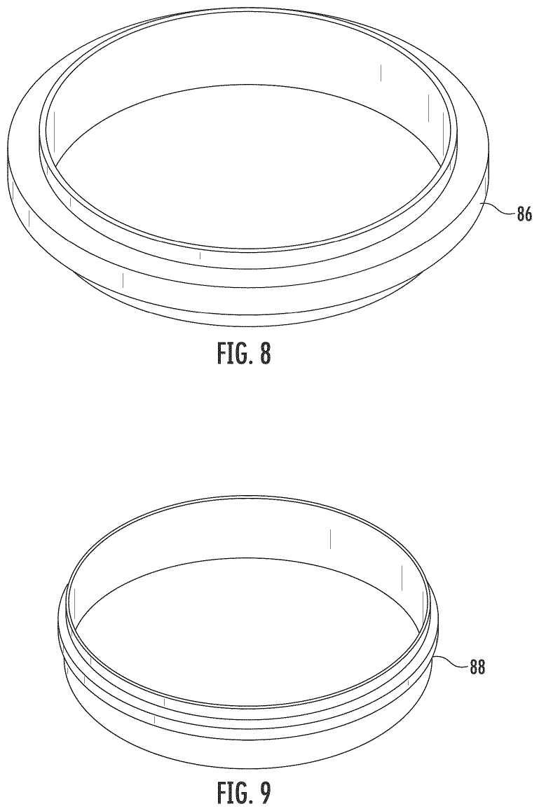

While the shrouds 60, 62 shown in FIG. 2, may also act as the assembly aid for holding the liquid adhesive during application, the shrouds 60, 62 may also be more simplistic ring members 86, 88 such as shown in FIGS. 8 and 9 that need to be used in connection with a mold 90, 92 (FIGS. 6 and 7), which together receive liquid adhesive for application to the bundle 44 of hollow membrane tubes 12. In this embodiment, adhesive for the composite end cap is in the form of an overmold which adhesive overmolds the preform to the composite end cap, wherein the preform can still provides at least part of the outermost radial surface of the composite end cap and the adhesive defines a molded surface overlapping the preform. For example, the simplistic ring members 86, 88 may correspond to and provide the outer surrounding rings 68, 70 (and an additional preform piece 94 for the inner end cap).

In either embodiment (overmold of FIGS. 6-9 or that of FIG. 2 as cut to FIG. 3), each of the first and second end caps comprises a cut end face 42 through the adhesive thereof exposing opposite open ends 40 of the hollow membrane tubes 12.

Further as shown in FIG. 3, the preform can be cut co-planar with the cut end for at least one of the first and second end caps, which can be done if cut through the preform or not.

Optionally, a perforated cage 96 (e.g. plastic molded cage with openings molded therein) can surround the bundle of hollow membrane tubes extending between the first and second end caps. This also can be located and if desired connected with the shrouds 60, 62 due to the preform nature thereof, providing reliability. The cage 96 can protect the open intermedia region 46 of the bundle 44 from damage and also provide support structure. Even with the cage 96, the hollow membranes tubes 10 are still externally exposed (due to the porosity for open gas exchange) in the intermediate region 46 between the first and second end caps 48, 50 for facilitating water vaper transfer via the hollow membrane tubes 12.

Turning to FIG. 5, another embodiment of an element 110 is shown that is the essentially the same as that of FIG. 4 other than this embodiment uses two closed end caps 148, 150 (compared to and open end cap 48 and a closed end cap 50), which facilitates a slightly different flow path, and has no need for the third seal 56. As such similar reference numbers will be used for like components that have similar functions (plus one-hundred for this embodiment), understanding that disclosure for the other embodiment(s) is applicable to this embodiment other than as expressly noted, and vice versa.

This element also includes a bundle 144 of hollow membrane tubes 112, however these are arranged in simple bundle collection rather than being ring-shaped. As a result there may not be an internal central cavity.

The end caps 148, 150 may also be of the same configuration making either end usable at the inlet end or outlet end. Each can also include similar first and second seal surfaces 152, 154 (discussion above for the earlier embodiment also applicable to this embodiment), and can both be composite end caps including adhesive 158 and preforms 160, 162 that have the same effect as the earlier embodiment (both may use a mold or have a cover portion to facilitate mold free; and can be optionally cut during exposure of open ends 140 at cut end faces 142)

Element 110 includes an intermediate region 146 of exposure of the hollow membrane tubes 112 between end caps 148, 150 to facilitate water vapor transfer between gas streams.

In particular, element 110 is usable in a similar assembly 116 with a housing comprising: a first inlet 128 and a first outlet 130; and a second inlet 132 and a second outlet 134. As shown by flow arrows in FIG. 5, the assembly 116 provides a first flow passageway 136 travelling from the first inlet 128 through the hollow membrane tubes 112 (and opposite open ends thereof) to the first outlet 130. The assembly 116 also provides a second flow passageway 138 through an intermediate region between two of the seal locations provided at first and second seal surfaces 152, 154 and between the second inlet 132 and the second outlet 134.

The assembly 116 is operable such that moisture is transferred from the first flow passageway 136 to the second flow passageway 138, or vice versa depending upon whether the first or second flow passageway has a higher moisture content. For example, reaction gas for a fuel cell may pass along the first flow passageway 136, whereas reacted/exhaust gas having a higher humidity may pass along the second flow passageway 138 to transfer water vapor to the reaction gas to improve operating effectiveness of the fuel cell (or vice versa with reaction gas along the second flow passageway 138 and reacted/exhaust gas along the first flow passageway 136).

Different embodiments can be made according to similar methods. A method for forming an element 10, 110, comprises: collecting a bundle 44, 144 of hollow membrane tubes 12, 112; applying a first composite end cap 48, 148 (or 50, 150) on a first end of the bundle with a first preform 60, 160 (or 62, 162) and adhesive 58, 158; curing the adhesive to encapsulate the bundle of hollow membrane tubes in the adhesive of the first composite end cap; and cutting through the first composite end cap and the first end of the bundle to expose open ends of the hollow membrane tubes at the first end (e.g. at one cut end face 42, 142). As noted above, the preform may or may not be cut through during the cutting.

The method preferably provides composite end caps at both ends and therefore comprises similarly applying a second composite end cap 50, 150 (or 48, 148) on a second end of the bundle with a second preform 62, 162 (or 60, 160) and adhesive 58, 158; curing the adhesive to encapsulate the bundle of hollow membrane tubes in the adhesive of the second composite end cap; cutting through the second composite end cap and the second end of the bundle to expose open ends of the hollow membrane tubes at the second end (e.g. at the other cut end face 42, 142); and maintaining exposure of an intermediate region 48, 148 of the bundle of hollow membranes tubes between the first and second composite end caps (which optionally can be protected by cage 96).

The method preferably comprises arranging an elastomeric gasket on either or both of the first and/or second composite end cap having a housing scaling surface. Alternatively if no elastomeric gasket is provided (and/or in addition to a gasket), the outer peripheral surface of the end cap(s) 48, 148, 50, 150 can be configured and toleranced for a sealing tight fit for housing sealing purposes, which may be facilitated by an outer peripheral surface of the preform thereof.

The method of applying either or both of the first and second composite end caps (48, 148, 50, 150) can comprises: i. locating an annular shroud (60, 62, 160, 162) as the preform within a mold (90, 92) having a cavity of a predetermined annular geometry, the annular shroud having an outer periphery substantially matching the annular geometry of the mold; inserting a first end of the bundle into the mold, such that ends of the hollow membrane tubes are internal of the first annular shroud; and applying adhesive (58, 158) into the first mold internal to the bundle to encapsulate the ends of the hollow membrane tubes.

### Further Details of Potential Useable Materials for the Various Embodiments Herein

The hollow membrane tubes 12, 112 can comprises hollow polymer fibers comprising a length of between 3 inches and 3 feet (corresponding to the length of an element 10); an opening area of opposite open ends being provided by tube 12 diameters that may vary from ½ inch up to ½ foot.

Suitable hollow membrane tubes 12, 112 usable in any of the foregoing embodiments are generally known in the art as may exemplified by: U.S. Patent Publication No. 2010/0190093 to Lee, which discloses hollow fiber membranes having a tube-type first hydrophilic polymer film having a hollow center, and a second hydrophilic polymer film coated on the inner surface of the tube-type first hydrophilic polymer film (for example, U.S. Patent Publication No. 2010/0190093 to Lee discloses that the tubes may have one or two films (preferably two films) and comprising fiber membrane material that can produced from polyetherimide (PEI), polyimide (PI), polyamideimide (PAY), polysulfone or polyethersulfone, a perfluorinated sulfonic acid copolymer, polyvinylalcohol (PVA) or polyacrylonitrile (PAN)); and/or by U.S. Publication No. 2008/0067700 to Korytnikov et al. which discloses hollow fibers, having water-permeable and micro-pores structure and are fabricated from polysulfone, polycarbonate, polyamide, and the like, adaptable to exchange humidity between two fluid streams, i.e. gas to gas or liquid to gas (the water permeability of the membrane being not higher than 10 ml/hr/mmHg to minimize the leakage of water carrier (DI water, humid gas) into the gas stream subject for the humidification); and/or those commercially available as indicated by U.S. Pat. No. 8,181,943 to Leister et. al. and/or Vaperma Siftek Technology (see https://www.greencarcongress.com/2009/03/uop-to-offer-va.html and EP 1,651,332 to Cranford et al./Vaperma, Inc.). Accordingly, the patent publications in this paragraph are incorporated by reference in their entirety as the membrane materials disclosed therein are usable in embodiments of the hollow membrane tubes 12, 112 of the present disclosure.

Suitable adhesive 58, 158 useable in any of the foregoing embodiments include but are not limited to various epoxies including 2 part epoxies, and various types of polyurethane or other such adhesives that may be applied in flowable viscous liquid form and cure-in-place.

The adhesive 58, 158 being applied in a flowable viscous liquid form will typically fill the interstices between the adjacent tubes to cause all or most of the fluid stream through the opposite open ends of the hollow membrane tubes 12, 112, sufficient to cause the desired effect of moisture separation and exchange purposes.

The preform(s) 60, 62, 160, 162 may take the form of a annular shroud that can be plastic injection molded before assembly such as from suitable plastic material such as nylon, PET (polyethylene terephthalate), polyethylene (HDPE or LDPE), PVC (polyvinyl chloride), PP (polypropylene), PS (polystyrene), and/or other plastic injection molded plastic materials. Other non-plastic materials may also be used for any of the preform(s) 60, 62, 160, 162 such metal for example.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention. The of conjunction “or” or “and/or” as used herein is meant to mean “inclusive or”, unless the context clearly indicates “exclusive or” interpretation.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An element, comprising:
a bundle of hollow membrane tubes, the hollow membrane tubes having opposite open ends for passage of a fluid stream therethrough;
first and second end caps proximate opposite open ends, respectively;
first and second seal surfaces provided by the first and second end caps, respectively, the first and second seal surfaces facing outwardly and freely engageable for facilitating a releasable seal;
an intermediate region of the bundle of hollow membranes tubes being externally exposed between the first and second end caps;
each of the first and second end caps at least partially formed with an adhesive, and
wherein at least one of the first and second end caps is a composite end cap comprising the adhesive in combination with a preform, the adhesive filling interstices between the hollow membrane tubes, the preform at least partially surrounding the bundle of hollow membrane tubes and integrally bonded thereto with the adhesive.

2. The element of claim 1, wherein both of the first and second end caps are composite end caps.

3. The element of claim 2, wherein the first end cap includes a first annular shroud as the preform, the second end cap includes a second annular shroud as the preform, wherein the first annular shroud and the second annular shroud have different configurations.

4. The element of claim 1, wherein each of the first and second seals surfaces comprise: (a) a free radially or axially directed annular surface of the first end cap or the second end cap; (b) a elastomeric ring gasket mounted to the first end cap or the second end cap; or (c) a lip seal integrally formed by the first end cap or the second end cap.

5. The element of claim 1, wherein the adhesive for the composite end cap is in the form of an overmold that overmolds the preform to the composite end cap, wherein the preform provides at least part of the outermost radial surface of the composite end cap and the adhesive defines a molded surface overlapping the preform.

6. The element of claim 1, wherein each of the first and second end caps comprises a cut end through the adhesive thereof exposing opposite open ends.

7. The element of claim 6, wherein the preform is cut therethrough and co-planar with the cut end for at least one of the first and second end caps.

8. The element of claim 6, wherein the preform is not cut therethrough.

9. The element of claim 1, wherein the preform comprises a ring portion surrounding the bundle.

10. The element of claim 1, further comprising a perforated cage surrounding the bundle of hollow membrane tubes extending between the first and second end caps.

11. The element of claim 1, wherein the first end cap is an open end cap and the second end cap is a closed end cap, and wherein the bundle of hollow membrane tubes is arranged in a ring defining a central cavity opening into an opening through the open end cap and closed at the closed end cap.

12. The element of claim 1 wherein the first and second end caps are closed end caps, passage therethrough being restricted to passage through the hollow membrane tubes via the opposite open ends thereof.

13. The element of claim 1, wherein the adhesive comprises polyurethane or epoxy.

14. The element of claim 1, wherein the preform comprises plastic or metal.

15. An assembly comprising the element of claim 1 and further comprising in combination a housing with the element removably installed therein forming first and second seals with the first and second seal surfaces, with the housing comprising: a first inlet and a first outlet, with a first flow passageway travelling from the first inlet through the hollow membrane tubes and opposite open ends thereof to the first outlet; and a second inlet and a second outlet, with a second flow passageway through the intermediate region, and operable such that moisture is transferred from the first flow passageway to the second flow passageway, or vice versa depending upon whether the first or second flow passageway has a higher moisture content.

16. A method for forming an element, comprising:
collecting a bundle of hollow membrane tubes;
applying a first composite end cap on a first end of the bundle with a first preform and adhesive;
curing the adhesive to encapsulate the bundle of hollow membrane tubes in the adhesive of the first composite end cap; and
cutting through the first composite end cap and the first end of the bundle to expose open ends of the hollow membrane tubes at the first end.

17. The method of claim 16, further comprising arranging an elastomeric gasket on the first composite end cap having a housing sealing surface.

18. The method of claim 16, wherein said applying the first composite end cap comprises:
i. locating a first annular shroud as the first preform within a first mold having a cavity of a predetermined annular geometry, the first annular shroud having an outer periphery substantially matching the annular geometry of the first mold;
ii. inserting a first end of the bundle into the mold, such that ends of the hollow membrane tubes are internal of the first annular shroud;
iii. applying adhesive into the first mold internal to the bundle to encapsulate the ends of the hollow membrane tubes.

19. The method of claim 16, further comprising applying a second composite end cap on a second end of the bundle with a second preform and adhesive;
curing the adhesive to encapsulate the bundle of hollow membrane tubes in the adhesive of the second composite end cap;
cutting through the second composite end cap and the second end of the bundle to expose open ends of the hollow membrane tubes at the second end; and
maintaining exposure of an intermediate region of the bundle of hollow membranes tubes between the first and second composite end caps.

20. The method of claim 19, wherein said applying the second composite end cap comprises:
i. locating a second annular shroud as the second preform within a second mold having a cavity of a predetermined annular geometry, the second annular shroud having an outer periphery substantially matching the annular geometry of the second mold;
ii. inserting the second end of the bundle into the mold, such that ends of the hollow membrane tubes are internal of the second annular shroud;
iii. applying adhesive into the second mold internal to the bundle to encapsulate the ends of the hollow membrane tubes.

21. A filter element including a ring of collected hollow fibers having a predetermined length, and end cap assemblies provided at each of the fiber ring, each end cap assembly including i) an annular pre-formed peripheral shroud surrounding the ends of the fibers; and ii) adhesive within the shroud and encapsulating the ends of the fibers.
